(19) United States
(12) Patent Application Publication
(10) Pub. No.: US 2011/0043445 A1
(43) Pub. Date: Feb. 24, 2011

(54) Handheld electronic device and method of controlling the handheld electronic device according to state thereof in a three-dimensional space

(75) Inventor: Chin-Te Kao, Taipei City (TW)

Correspondence Address: BACON & THOMAS, PLLC, 625 SLATERS LANE, FOURTH FLOOR, ALEXANDRIA, VA, 22314-1176, US

(73) Assignee: AIDEM SYSTEMS INC., Taipei City (TW)

(21) Appl. No.: 12/926,204

(22) Filed: Nov. 2, 2010

(30) Foreign Application Priority Data
Jun. 21, 2010 (TW) 099120053

(51) Int. Cl. G06F 3/01

(52) U.S. Cl. 345/156

(57) ABSTRACT

A method of controlling a handheld electronic device according to state thereof in a three-dimensional space, which is applicable to the handheld electronic device including a CPU, a displacement sensor, and a quadrant section lookup table. The displacement sensor detects variation of the state of the handheld electronic device in a three-dimensional space and generates a current state signal accordingly. The lookup table lists a plurality of quadrant sections of the three-dimensional space, wherein each quadrant section corresponds to a function program or control command. The CPU receives the current state signal and calculates a current space signal accordingly. After determining the quadrant section in the lookup table that corresponds to the current space signal, the CPU activates the function program or control command that corresponds to the quadrant section. Thus, a user can execute the desired function programs or control commands conveniently by moving the handheld electronic device single-handedly.

### FIELD OF THE INVENTION

The present invention relates to a method of controlling a handheld electronic device, and more particularly to a method for enabling a handheld electronic device to be operated only by a single hand of a user and directly activate corresponding function programs or control commands according to position thereof in a three-dimensional space, so as to significantly increase the convenience of operation of the handheld electronic device.

### BACKGROUND OF THE INVENTION

According to a report recently published by the International Telecommunication Union (ITU), the number of mobile phone users around the globe has reached 4.6 billion at the end of 2009, with a penetration rate of 67%. As mobile phones have become a basic means of interpersonal communication, mobile phone companies nowadays make great effort to cater to consumers' constant desire for change, with a view to securing a larger market share. Hence, not only are mobile phones made increasingly smaller and lighter, but also a variety of functions and additional services, such as picture taking, video recording, web surfing, gaming, radio, and so on, have been integrated into a single mobile phone to appeal to potential buyers.

Indeed, today's mobile phones have met most people's requirements. A mobile phone can be easily carried around and serves simultaneously as a digital camera, a portable audio player, a game console, and so forth. However, the increase in functions and the decrease in size of mobile phones have caused inconveniences in use. First of all, as the number of keys on mobile phones decreases, users are often required to press certain keys repeatedly in order to select the desired function programs or give the correct control commands for activating the services in need. Secondly, as the overall product size is reduced, the keys are made smaller, too, making it difficult to press the intended keys. Moreover, during the key pressing process, it is very likely that the unintended keys are inadvertently pressed, and in consequence the wrong services are activated, thus compromising the convenience of operation of mobile phones. To spare users the aforesaid problems, touch screens have been incorporated into mobile phones so that the desired function programs or control commands can be selected simply by touching the touch screen with a finger. Nonetheless, touch screens, though capable of enabling convenient selection of the various functions of mobile phones, are disadvantaged by a high production cost. In addition, as a capacitive touch screen must be operated with a bare finger but not a gloved hand, it will definitely be harsh to operate a capacitive touch screen mobile phone on a cold winter day. Furthermore, a mobile phone equipped with a touch screen must be held in one hand and operated by the other hand pressing on the touch screen. In other words, a user cannot control such a mobile phone with only one hand. Therefore, there is still much room for improvement of such mobile phones in terms of convenience.

Presently, with user-friendliness being at the core of industrial design, it has become an important issue for electronic device manufacturers to increase the convenience of use of mobile phones or other handheld electronic devices (e.g., PDAs, GPS navigators, etc.) and thereby develop new products that live up to consumers' expectations.

### BRIEF SUMMARY OF THE INVENTION

In view of the fact that conventional handheld electronic devices are not convenient enough to be operable with only one hand in activating the desired services, and in order to effectively solve the aforementioned problems, the inventor of the present invention conducted extensive research and experiment and finally succeeded in developing a handheld electronic device and method of controlling the handheld electronic device according to state thereof in a three-dimensional space.

It is an object of the present invention to provide a handheld electronic device (e.g., a mobile phone, PDA, GPS navigator, etc.) which is controlled according to its own state in a three-dimensional space. The handheld electronic device includes a central processing unit (CPU), a displacement sensor, and a quadrant section lookup table. The displacement sensor is configured to detect variation of the state of the handheld electronic device in a three-dimensional space (e.g., the roll angle of the horizontal longitudinal axis (e.g., Y-axis), the pitch angle of the horizontal transverse axis (e.g., X-axis), and the yaw angle of the vertical axis (e.g., Z-axis), or variation of the azimuth angle) and generate a current state signal accordingly. The CPU is configured to receive the current state signal from the displacement sensor and calculate a current space signal according to the current state signal. The quadrant section lookup table lists a plurality of quadrant sections of the three-dimensional space, wherein each quadrant section corresponds to a function program (e.g., “Contacts”, “Games”, “Recorder”, etc.) or a control command (e.g., “Execute”, “Change page”, “Move cursor”, etc.). By checking the current space signal against the quadrant section lookup table, the CPU determines the quadrant section where the handheld electronic device ends up in the three-dimensional space. Then, the CPU activates the function program or control command that corresponds to the quadrant section. Thus, according to the quadrant section where the handheld electronic device is located, the handheld electronic device automatically executes the corresponding function program or control command. In consequence, a more user-friendly control mechanism than the prior art is achieved.

It is another object of the present invention to provide a method of controlling the handheld electronic device according to state thereof in a three-dimensional space, wherein the method is applicable to the handheld electronic device described in the previous paragraph and includes the following steps. After calculating the current space signal, the CPU determines, according to the quadrant section lookup table, which quadrant section therein corresponds to the current space signal; hence, the quadrant section where the handheld electronic device is eventually situated in the three-dimensional space is determined. Then, according to the quadrant section lookup table, the function program or control command that corresponds to the quadrant section is activated or executed. Therefore, by planning the plurality of quadrant sections in advance and assigning a function program or control command to each quadrant section, the desired function programs or control commands can be automatically executed in response to displacement of the handheld electronic device.

### BRIEF DESCRIPTION OF THE SEVERAL VIEWS OF THE DRAWINGS

A detailed description of further features and advantages of the present invention is given below with reference to the accompanying drawings, in which:

FIG. 1 schematically shows displacements of an airplane in a three-dimensional space;

FIG. 2 is the hardware block diagram of an electronic device according to the present invention;

FIG. 3 schematically shows the planning of a quadrant section lookup table according to the present invention; and

FIG. 4 is a flowchart of the present invention.

### DETAILED DESCRIPTION OF THE INVENTION

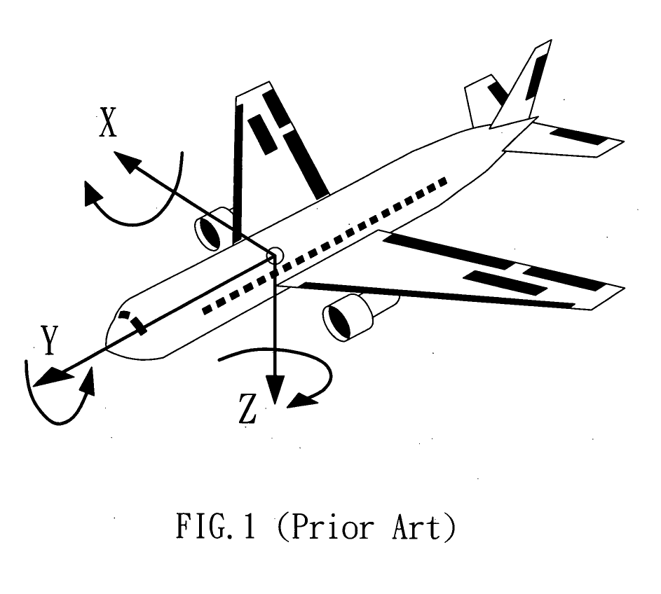

Generally speaking, a three-dimensional space is defined by a length, a height, and a depth. Therefore, the moving direction and angle of an object in a three-dimensional space can be known by detecting the roll angle of the object's horizontal longitudinal axis (e.g., Y-axis), the pitch angle of the object's horizontal transverse axis (e.g., X-axis), and the yaw angle of the object's vertical axis (e.g., Z-axis), or by detecting variation of the object's azimuth angle. With the development of the high-tech industry, the application techniques of three-dimensional space have gradually matured and are used in a variety of devices or products, such as airplanes (whose X-, Y-, and Z-axes are illustrated in FIG. 1), the home video game console Wii, etc. Based on the aforesaid publicly known techniques, the present applicant has successfully developed a novel method for operating a handheld electronic device so that the conventional handheld electronic devices can be improved especially in terms of convenience of use.

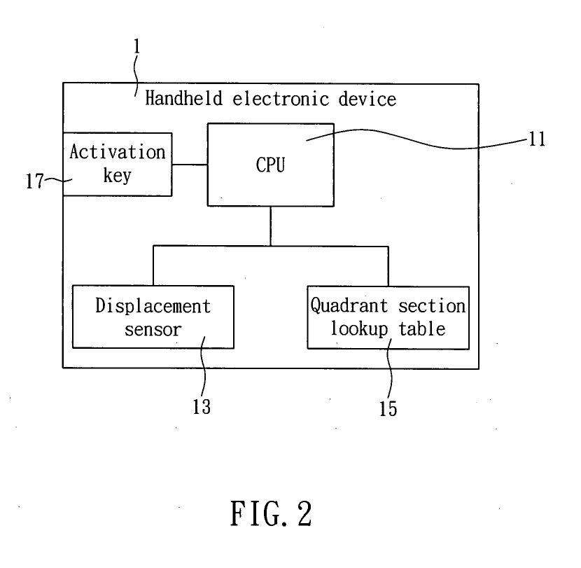

The present invention provides a handheld electronic device and a method of controlling the handheld electronic device according to state thereof in a three-dimensional space. In a preferred embodiment of the present invention, referring to FIG. 2, a handheld electronic device 1 (e.g., a mobile phone, PDA, GPS navigator, etc.) includes a central processing unit (CPU) 11, a displacement sensor 13, and a quadrant section lookup table 15. The CPU 11 is respectively and electrically connected to the displacement sensor 13 and the quadrant section lookup table 15 so as to transmit/receive various data or control signals to/from the displacement sensor 13 and the quadrant section lookup table 15. The displacement sensor 13, which is a compass and gravity-sensor or a gyro, serves mainly to detect the roll angle of the horizontal longitudinal axis of the handheld electronic device 1, the pitch angle of the horizontal transverse axis of the handheld electronic device 1, and the yaw angle of the vertical axis of the handheld electronic device 1. For example, the displacement sensor 13 can detect whether the handheld electronic device 1 is moved from an original position toward the upper right or toward the lower left. The displacement sensor 13 detects not only state variation but also the final location of the handheld electronic device 1 in a three-dimensional space and then generates a current state signal correspondingly, wherein the current state signal includes angular values corresponding to the roll angle, pitch angle and yaw angle and a length value from a center point of the handheld electronic device to an origin of the three-dimensional space. As the displacement sensor 13 is now commercially available in various types and is a well-known and widely used device, the detection method of the displacement sensor 13 is not described herein.

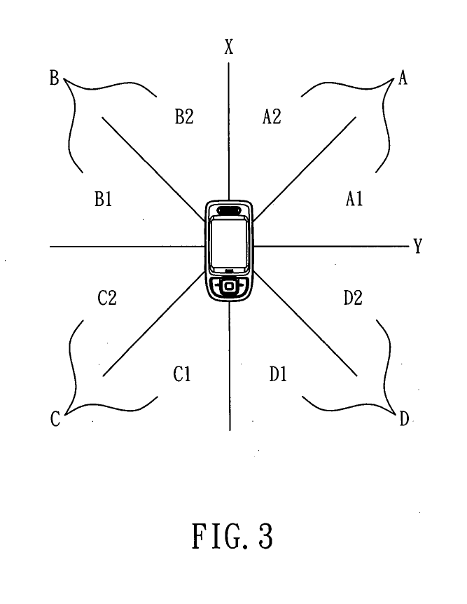

By definition, a quadrant is any of the four quarters divided by two intersecting axes. Therefore, the X- and Y-axes define four quadrants, the X- and Z-axes define four quadrants, and the Z- and Y-axes define four quadrants. In addition, each quadrant can be further divided into a plurality of quadrant sections. To clearly disclose the technical means of the present invention, the four quadrants defined by the X- and Y-axes are used in the following description by way of example. Referring to FIG. 2 and FIG. 3, the quadrant section lookup table 15 lists a plurality of quadrant sections of the three-dimensional space. More specifically, the X-axis and the Y-axis define a first quadrant A, a second quadrant B, a third quadrant C, and a fourth quadrant D, wherein the first quadrant A is divided into a first lower quadrant section A1 and a first upper quadrant section A2, the second quadrant B into a second lower quadrant section B1 and a second upper quadrant section B2, the third quadrant C into a third lower quadrant section C1 and a third upper quadrant section C2, and the fourth quadrant D into a fourth lower quadrant section D1 and a fourth upper quadrant section D2. Hence, the quadrant section lookup table 15 contains a total of eight quadrant sections, and each quadrant section corresponds to a function program (e.g., “Contacts”, “Games”, “Recorder”, etc.) or a control command (e.g., “Execute”, “Change page”, “Move cursor”, etc.). In other embodiments of the present invention, however, the number and arrangement of the quadrant sections may vary according to design requirements. For instance, there can be nine quadrant sections arranged in a 3×3 array so that a user can move the handheld electronic device 1 to any of the nine arrayed quadrant sections.

Referring again to FIG. 2, the displacement sensor 13, upon detecting a displacement of the handheld electronic device 1, packs the angular values and displacement value resulting from the displacement into a current space signal and transmits the current space signal to the CPU 11. After receiving the current space signal, the CPU 11 performs calculation on the angular values and the length value and reads the quadrant section lookup table 15 so as to determine, according to all the quadrant sections listed in the quadrant section lookup table 15, which quadrant section in the quadrant section lookup table 15 corresponds to the current space signal. Thus, the quadrant section where the handheld electronic device 1 ends up in the three-dimensional space is determined. If the quadrant section where the handheld electronic device 1 is situated is already included in the quadrant section lookup table 15 and is assigned the corresponding function program or control command, the CPU 11 will activate the function program or execute the control command. However, if the quadrant section where the handheld electronic device 1 is located is not included in the quadrant section lookup table 15, or if the quadrant section is not assigned any function program or control command, the CPU 11 will take no further action. With each quadrant section being assigned a function program or control command in advance, the user can move the handheld electronic device 1 single-handedly to the predetermined quadrant sections so as for the handheld electronic device 1 to automatically execute the desired function programs or control commands, without any key being pressed. Thus, not only is operational convenience enhanced, but also a highly user-friendly operation mechanism is provided.

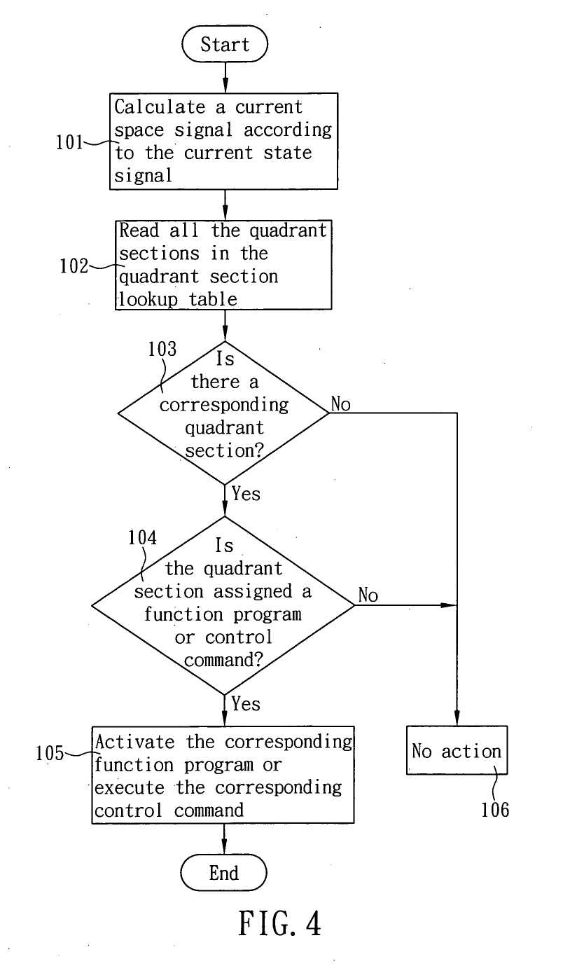

To further illustrate the steps of the disclosed control method, the processing procedure of the CPU 11 is detailed as follows. Referring to FIG. 2 and FIG. 4, the CPU 11 performs the following steps upon receiving the current state signal:
(101) Calculate the current space signal according to the angular values and the length value in the current state signal. Then, move on to Step (102).
(102) Read all the quadrant sections listed in the quadrant section lookup table 15. Then, move on to Step (103).
(103) Determine whether there is a quadrant section in the quadrant section lookup table 15 that corresponds to the current space signal. If yes, go to Step (104); if no, go to Step (106).
(104) Determine whether the quadrant section is assigned a function program or control command. If yes, go to Step (105); if no, go to Step (106).
(105) Read the function program or control command corresponding to the quadrant section. Then, activate the function program or execute the control command.
(106) No action.

Based on the above flowchart, a user can control the handheld electronic device 1 and execute the desired function programs or control commands simply by moving the handheld electronic device 1 with one hand. For instance, referring to FIGS. 2 and 3, wherein the handheld electronic device 1 is a mobile phone, and the first lower quadrant section A1 is assigned the function program to start “Contacts”, a user wishing to start “Contacts” in the mobile phone while walking on a rainy street with an umbrella in one hand only has to move the mobile phone single-handedly to the first lower quadrant section A1, and the mobile phone will automatically activate the function program to start “Contacts”. As the user need not walk deliberately to an arcade to free the umbrella-holding hand and operate the mobile phone with both hands as is conventionally required, the convenience of operation of the mobile phone is significantly increased. In addition, it should be pointed out that, in a different embodiment of the present invention, the handheld electronic device 1 further includes an activation key 17 electrically connected to the CPU 11. When pressed, the activation key 17 transmits an activation signal to the CPU 11 so that the displacement sensor 13 is activated by the CPU 11 to begin detecting variation of the state of the handheld electronic device 1 in a three-dimensional space. The provision of the activation key 17 is intended to prevent the handheld electronic device 1 from accidentally activating unintended function programs. In another embodiment of the present invention, the activation key 17 is directly electrically connected to the displacement sensor 13, and the activation signal is therefore directly sent to the displacement sensor 13 to activate its detection function. Alternatively, the activation key 17 is not a physical key but a virtual key on a screen of the handheld electronic device 1. The configuration and position of the activation key 17 are not limited to those described herein, provided that the activation key 17 can transmit the activation signal and allow the handheld electronic device 1 to be controlled by the method of the invention.

The vocabulary used to describe the embodiments of the present invention is for explicative purposes only and should not be construed as restrictive. Furthermore, it should be understood that the quadrant section lookup table 15 is depicted in FIG. 2 as external of the CPU 11 only for the convenience of illustration, with a view to enabling the general public or those in the industry to readily comprehend the substance and essential features of the present invention rather than to limiting the hardware structure disclosed herein. In practice, a person skilled in the art should be able to grasp the technical features of the present invention and integrate the quadrant section lookup table 15 into the CPU 11. The embodiments described above are only the preferred embodiments but are not intended to limit the scope of the present invention. All equivalent changes which are easily conceivable by a person skilled in the art and are based on the disclosed technical contents should fall within the scope of the present invention, which is defined only by the appended claims.

What is claimed is:

1. A method of controlling a handheld electronic device according to state thereof in a three-dimensional space, which is applied to the handheld electronic device comprising a central processing unit (CPU), a displacement sensor and a quadrant section lookup table, wherein the displacement sensor is configured to detect variation of the state of the handheld electronic device in the three-dimensional space and generate a current state signal accordingly, the quadrant section lookup table lists a plurality of quadrant sections of the three-dimensional space, and each said quadrant section corresponds to a function program or a control command, the method comprising the steps, performed by the CPU upon receiving the current state signal, of:
calculating a current space signal according to the current state signal;
determining, according to the quadrant section lookup table, the quadrant section therein that corresponds to the current space signal and thereby determining the quadrant section where the handheld electronic device is eventually situated in the three-dimensional space; and
activating the function program that, according to the quadrant section lookup table, corresponds to the quadrant section; or executing the control command that, according to the quadrant section lookup table, corresponds to the quadrant section.

2. The method of claim 1, wherein the handheld electronic device further comprises an activation key electrically connected to the CPU and configured to generate an activation signal, and wherein the CPU receives the activation signal and activates the displacement sensor for detection, before receiving the current state signal.

3. The method of claim 1, wherein the current state signal comprises angular values corresponding to a roll angle, a pitch angle and a yaw angle of the three-dimensional space and a length value from a center point of the handheld electronic device to an origin of the three-dimensional space.

4. A handheld electronic device controlled according to state thereof in a three-dimensional space, comprising:
a displacement sensor for detecting variation of the state of the handheld electronic device in the three-dimensional state and generating a current state signal accordingly;
a quadrant section lookup table listing a plurality of quadrant sections of the three-dimensional space, wherein each said quadrant section corresponds to a function program or a control command; and
a central processing unit (CPU) respectively and electrically connected to the displacement sensor and the quadrant section lookup table and configured for performing calculation on the current state signal so as to determine the quadrant section where the handheld electronic device is eventually situated in the three-dimensional space and activate the function program corresponding to the quadrant section or execute the control command corresponding to the quadrant section.

5. The handheld electronic device of claim 4, further comprising an activation key, wherein the activation key is electrically connected to the CPU and is configured to generate an activation signal and transmit the activation signal to the CPU so as for the CPU to activate the displacement sensor for detection.

6. The handheld electronic device of claim 4, further comprising an activation key, wherein the activation key is electrically connected to the displacement sensor and is configured to generate an activation signal and transmit the activation signal to the displacement sensor so as to activate the displacement sensor for detection.

7. The handheld electronic device of claim 5, wherein the displacement sensor is a compass and gravity-sensor.

8. The handheld electronic device of claim 6, wherein the displacement sensor is a compass and gravity-sensor.

9. The handheld electronic device of claim 5, wherein the displacement sensor is a gyro.

10. The handheld electronic device of claim 6, wherein the displacement sensor is a gyro.
